(19) United States
(12) Patent Application Publication
(10) Pub. No.: US 2025/0072670 A1
(43) Pub. Date: Mar. 6, 2025

(54) READY-TO-USE HAND SOAP SYSTEM DRIVING PROGRAM EFFICIENCIES, SUSTAINABILITY AND COMPLIANCE WITH IMPROVED COMPOSITION AND AIR TO PRODUCT PUMP RATIOS

(71) Applicant: ECOLAB USA INC., Saint Paul, MN (US)

(72) Inventors: Hilina Emiru, Rosemount, MN (US); Wendy Lo, Woodbury, MN (US); Joseph Steven Bons, Oakdale, MN (US); Devon Beau Hammel, Minneapolis, MN (US); Joseph R. Wegner, Falcon Heights, MN (US)

(21) Appl. No.: 18/816,425

(22) Filed: Aug. 27, 2024

Related U.S. Application Data
(60) Provisional application No. 63/579,202, filed on Aug. 28, 2023.

(51) Int. Cl. A47K 5/14; A47K 5/12; A61Q 19/10

(52) U.S. Cl. CPC A47K 5/14; A47K 5/1211; A47K 5/1217; A61Q 19/10

(57) ABSTRACT

Disclosed herein are foaming compositions that efficiently remove soils from surfaces and tissues comprising a primary surfactant, secondary surfactant, foam booster, and optionally a solvent. Also disclosed are methods of using the same to remove soil from surfaces and tissues, including hands. In particular, the compositions are preferably dispensed via a pump with a high composition to air ratio which reduces waste substantially while still maintaining effective foaming, soil removal, and user experience.

### CROSS-REFERENCE TO RELATED APPLICATIONS

This application claims priority under 35 U.S.C. § 119 to U.S. Provisional Application Ser. No. 63/579,202, filed Aug. 28, 2023, which is herein incorporated by reference in its entirety, including without limitation, the figures, tables, examples, and claims.

### TECHNICAL FIELD

The present disclosure relates to a hand soap system utilizing a foaming hand soap composition, wherein the ratio of air to composition improves product longevity, improves sustainability, and reduces packaging waste without impacting cleaning efficacy or user experience.

### TECHNICAL BACKGROUND

Effective hand hygiene has been recognized as an effective way to reduce pathogen and soil transmission in a variety of settings, such as food service and health care industries. Good hand hygiene is facilitated through a combination of effective product chemistry and efficient product dispensing solutions. Existing hand hygiene systems generally suffer from inefficiencies in product dispensation, wherein either too much or too little product is dispensed in one action. Too little product can reduce cleaning efficacy or cause users to require multiple doses of product in order to obtain sufficient cleaning capabilities. Alternatively, excessive product dispensation results in product waste, increased frequency of soap cartridge change out, decreased sustainability, and poor user experience. There is therefore a need to develop hand hygiene systems that deliver a volume and concentration of product such that cleaning efficacy is maximized and waste is minimized.

Although products can be dispensed in a variety of forms (e.g., liquid, solid), foam product is particularly desirable in many applications, as product and air are mixed to create a high volume, easy to use dose. However, many foaming hand hygiene systems suffer from deficiencies such as loss of priming and poor foam production. In such cases, users must prime the pump one or more times to generate foam, or the product is dispensed in the form of a low foam liquid. These deficiencies contribute to poor user experience and can decrease cleaning efficacy.

There is therefore a need to develop improved foaming hand hygiene systems, wherein the cleaning composition exhibits phase and foam stability, particularly when combined with air to generate the foam.

There is a further need to develop improved foaming hand hygiene systems wherein the cleaning compositions generates stable foam for the entire surface washing (e.g., hand washing) process, preferably for between about 30 seconds and about 60 seconds.

These and other objects, advantages, and features of the present disclosure will become apparent from the following specification taken in conjunction with the claims set forth herein.

### BRIEF SUMMARY

Disclosed herein are foaming compositions comprising:
a primary surfactant;
a secondary surfactant;
a foam booster;
and optionally a solvent.

In an embodiment, the composition is a ready-to-use (RTU) liquid having an air to composition ratio of between about 22-28 and about 1 when dispensed from a pump.

In an embodiment, the primary surfactant is sodium laureth sulfate, sodium lauryl sulfate, sodium dodecyl benzene sulfonate, an alkyl sulfonate, an ether carboxylic acid, a sulfonated fatty acid, a cationic surfactant, a salt of C12-C16 saturated or unsaturated fatty acid, lauryl dimethyl amine oxide, myristyl dimethyl amine oxide, cetyl dimethyl amine oxide, or a combination thereof.

In an embodiment, the secondary surfactant is a C8-C16 alkyl polyglucoside, C12-C16 alkyl polyglucoside, lauryl/myristyl glucoside, or a combination thereof.

In an embodiment, the foam booster is a glyceryl caprylate/caprate sorbitan sesquicaprylate, phospholipid, polyethylene glycol, capric/caprylic monoglyceride, cocamidopropyl PG-dimonium chloride, cocamidopropyl betaine, or a combination thereof.

In an embodiment, the solvent is an alcohol, alkanol amine, ether amine, glycol ether, hexylene glycol, or a combination thereof.

In an embodiment, the composition comprises from about 1 wt. % to about 15 wt. % of the primary surfactant; from about 0.25 wt. % to about 5 wt. % of the secondary surfactant; from about 0.25 wt. % to about 5 wt. % of the foam booster; and up to about 5 wt. % of the solvent.

In an embodiment, the compositions further comprise an additional functional ingredient. In an embodiment, the additional functional ingredient comprises water, a preservative, a pH modifier, a viscosity modifier, a skin health agent, an antimicrobial agent, a solubility modifier, a fragrance, a dye, a hydrotrope, buffer, additional surfactant, or a combination thereof. In an embodiment, the skin health agent comprises glycerin, aloe vera, polyethylene glycol, propylene glycol, Vitamin E, panthenol, urea, methyl gluceth-20, sorbitol, or a combination thereof. In an embodiment, the skin health agent is present in an amount of between about 0.2 wt. % to about 2 wt. %.

In an embodiment, the pH of the composition is between about 4 to about 9.5.

In an embodiment, the composition is a foaming hand soap.

In an embodiment, the hand soap does not cause irritancy to skin of a user and wherein the hand soap does not leave residue on the skin of the user.

In an embodiment, the compositions have a viscosity of less than 50 Cp·s.

In an embodiment, the composition has a density of between about 18 ml/g to about 27 ml/g. In an embodiment, the composition has a density of between about 18 ml/g to about 25 ml/g. In an embodiment, the composition has a density of between about 18 ml/g to about 22 ml/g.

Also disclosed are methods of removing soil from a tissue or surface comprising:
applying the composition according to any one of claims 1-17 to a tissue or surface;
and removing the soil from the tissue or surface.

In an embodiment, the methods further comprise a step of dispensing the composition.

In an embodiment of the methods, the compositions are dispensed using a foaming pump. In an embodiment of the methods, the compositions are dispensed from the foaming pump in a dose having between about 0.3 ml to about 0.8 ml of the composition, or up to 1.0 ml of the composition.

In an embodiment, the tissue is skin. In an embodiment, the surface is a hard surface comprising a table, countertop, tile, floor, wall, panel, window, food processing surface. In an embodiment, the surface is a soft surface comprising paper, or a textile. In an embodiment, the method does not require a step of priming the pump. In an embodiment, the method does not require a step priming the pump more than once.

While multiple embodiments are disclosed, still other embodiments of the present disclosure will become apparent based on the detailed description, which shows and describes illustrative embodiments of the disclosure. The foregoing summary is illustrative only and is not intended to be in any way limiting. In addition to the illustrative aspects, embodiments, and features described above, further aspects, embodiments, and features of the present technology are apparent from the following drawings and the detailed description, which shows and describes illustrative embodiments of the present technology.

The methods and compositions described herein, including each individual step of a method and component of a composition may be combined with any of the other methods and compositions described herein. Each feature of the technology described herein may be combined with any one or more other features of the disclosure, e.g., the methods may be used with any variation of the composition described herein. Accordingly, the drawings and detailed description are to be regarded as illustrative and not restrictive.

### BRIEF DESCRIPTION OF THE DRAWINGS

FIG. 1 shows an evaluation of the average foam density of the compositions according to the disclosure and control/comparison formulations.

FIG. 2 shows an additional evaluation of the average foam density of the compositions according to the disclosure and control/comparison formulations.

FIG. 3 shows the percentage of fatty soil removal.

FIG. 4 depicts the changes in overall behavior (i.e., total dispensing, repeat dispensing) of users when using foam hand soaps.

FIG. 5 shows the product preferences of the sensory panel.

FIG. 6 illustrates the model-predicted differences between products evaluated by the sensory panel.

Various embodiments of the present disclosure will be described in detail regarding the drawings. Reference to various embodiments does not limit the scope of the disclosure. The figures represented herein are not limitations to the various embodiments according to the disclosure and are presented as an example illustration of the disclosure.

### DETAILED DESCRIPTION OF THE PREFERRED EMBODIMENTS

The present disclosure relates to foaming hand wash compositions that provide effective soil removal efficacy and antimicrobial efficacy and are suitable for application on a variety of surfaces, such as skin surfaces. Also disclosed herein are methods of making and using the same.

It is an advantage that the compositions and methods disclosed herein provide highly effective compositions even in a low concentration dose. In particular, it is an advantage that the compositions are dispensed with a high product to air ratio of between about 22-28 to about 1.

The embodiments of this disclosure are not limited to particular types of compositions or methods, which can vary. It is further to be understood that all terminology used herein is to describe particular embodiments only and is not intended to be limiting in any manner or scope. For example, as used in this specification and the appended claims, the singular forms “a,” “an” and “the” can include plural referents unless the context indicates otherwise. Unless indicated otherwise, “or” can mean any one alone or any combination thereof, e.g., “A, B, or C” means the same as any of A alone, B alone, C alone, “A and B,” “A and C,” “B and C” or “A, B, and C.” Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, a description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 11/2, and 43/4 This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The terms “a,” “an,” and “the” include both singular and plural referents.

The term “or” is synonymous with “and/or” and means any one member or combination of members of a particular list.

The term “about,” as used herein, refers to variation in the numerical quantity that can occur, for example, through typical measuring techniques and equipment, with respect to any quantifiable variable, including, but not limited to, mass, volume, time, temperature, pH, reflectance, whiteness, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refer to the concentration of those ingredients involved in cleaning expressed as a percentage minus inert ingredients such as water or salts.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

As used herein, the term “soil” refers to polar or non-polar organic or inorganic substances including, but not limited to carbohydrates, proteins, fats, oils, and the like which may or may not contain particulate matter such as mineral clays, sand, natural mineral matter, carbon black, graphite, kaolin, environmental dust, colorant, dyes, polymers, and oils. These substances may be present in their organic state or complexed to a metal to form an inorganic complex. The terms “soil” and “stain” include, but are not limited to, oil-based stains.

As used herein, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to carbon(s) or hydrogen(s) atoms replaced by one or more bonds, including double or triple bonds, to a heteroatom. Thus, a substituted group is substituted with one or more substituents, unless otherwise specified. A substituted group can be substituted with 1, 2, 3, 4, 5, or 6 substituents.

Substituted ring groups include rings and ring systems in which a bond to a hydrogen atom is replaced with a bond to a carbon atom. Therefore, substituted cycloalkyl, aryl, heterocyclic, and heteroaryl groups may also be substituted with substituted or unsubstituted alkyl, alkenyl, and alkynyl groups are defined herein.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having two to about 30 carbon atoms, and further including at least one double bond. In some embodiments, an alkenyl group has from 2 to about 30 carbon atoms, or typically, from 2 to 10 carbon atoms. Alkenyl groups may be substituted or unsubstituted. For a double bond in an alkenyl group, the configuration for the double bond can be a trans or cis configuration. Alkenyl groups may be substituted similarly to alkyl groups.

Alkynyl groups are straight chain, branched, or cyclic alkyl groups having two to about 30 carbon atoms, and further including at least one triple bond. In some embodiments, an alkynyl group has from 2 to about 30 carbon atoms, or typically, from 2 to 10 carbon atoms. Alkynyl groups may be substituted or unsubstituted. Alkynyl groups may be substituted similarly to alkyl or alkenyl groups.

As used herein, the terms “alkylene”, “cycloalkylene”, “alkynylides”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

The term “ester” as used herein refers to —RCOOR¹ group. R is absent, a substituted or unsubstituted alkylene, cycloalkylene, alkenylene, alkynylene, arylene, aralkylene, heterocyclylalkylene, or heterocyclylene group as defined herein. R¹ is a substituted or unsubstituted alkyl, cycloalkyl, alkenyl, alkynyl, aryl, aralkyl, heterocyclylalkyl, or heterocyclyl group as defined herein.

The term “amine” (or “amino”) as used herein refers to —RNR¹R² groups. R is absent, a substituted or unsubstituted alkylene, cycloalkylene, alkenylene, alkynylene, arylene, aralkylene, heterocyclylalkylene, or heterocyclylene group as defined herein. R¹ and R² are independently hydrogen, or a substituted or unsubstituted alkyl, cycloalkyl, alkenyl, alkynyl, aryl, aralkyl, heterocyclylalkyl, or heterocyclyl group as defined herein.

The term “amine” as used herein also refers to an independent compound. When an amine is a compound, it can be represented by a formula of RNR¹R² groups, wherein R, R¹, and R² are independently hydrogen, or a substituted or unsubstituted alkyl, cycloalkyl, alkenyl, alkynyl, aryl, aralkyl, heterocyclylalkyl, or heterocyclyl group as defined herein.

The term “alcohol” as used herein refers to —ROH groups. R is absent, a substituted or unsubstituted alkylene, cycloalkylene, alkenylene, alkynylene, arylene, aralkylene, heterocyclylalkylene, or heterocyclylene group as defined herein.

The term “carboxylic acid” as used herein refers to —RCOOH groups. R is absent, a substituted or unsubstituted alkylene, cycloalkylene, alkenylene, alkynylene, arylene, aralkylene, heterocyclylalkylene, or heterocyclylene group as defined herein.

As used herein, the term “free,” “no,” “substantially no,” or “substantially free” refers to a composition, mixture, or ingredient that does not contain a particular compound or to which a particular compound or a particular compound-containing compound has not been added. In some embodiments, the reduction and/or elimination of hydrogen peroxide according to embodiments provide hydrogen peroxide-free or substantially-free compositions. Should the particular compound be present through contamination and/or use in a minimal amount of a composition, mixture, or ingredients, the amount of the compound shall be less than about 3 wt. %. More preferably, the amount of the compound is less than 2 wt. %, less than 1 wt. %, and most preferably the amount of the compound is less than 0.5 wt. % or 0 wt. %.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “hard surface” refers to a solid, substantially non-flexible surface such as a countertop, tile, floor, wall, panel, window, and/or food processing surface. The phrase “food processing surface” refers to a surface of a tool, a machine, equipment, a structure, a building, or the like that is employed as part of a food or beverage processing, preparation, or storage activity.

The term “soft surface” includes, for example paper, filter media, linens, garments, and textiles. Such soft surfaces may be made from a variety of materials including, for example, paper, fiber, woven or non-woven fabric, soft plastics and elastomers.

The methods, systems, apparatuses, and compositions disclosed herein may comprise, consist essentially of, or consist of the components and ingredients described herein as well as other ingredients not described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

The “scope” of the present disclosure is defined by the claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

### Compositions

Exemplary ranges of the compositions are shown in Table 1, Table 2, and Table 3 below in weight percentage of the compositions, preferably the solid compositions for Tables 1-2 and ready-to-use compositions for Table 3.

TABLE 1

| | Concentration |
|---|---|
| Description | (wt. %) |
| Antimicrobial Agent | 0.1-1.3 |
| Primary Surfactant | 1.0-15.0 |
| Secondary Surfactant | 0.25-5.0 |
| Foam Booster | 0.25-5.0 |
| Solvent | 0.5-5.0 |
| Preservative(s) | 0.025-1.5 |
| Additional functional ingredients | 0.0-30 |
| Water | Diluent |
| pH of Solution | 4.0-9.5 |

TABLE 2

| | Concentration |
|---|---|
| Description | (wt. %) |
| Anionic Primary Surfactant | 5-25 |
| Secondary Nonionic Surfactant | 0.5-5 |
| Secondary Amphoteric Surfactant | 0.5-5 |
| Foam Booster | 0.1-3 |
| Solvent(s) | 0.1-3 |
| Preservative(s) | 0.01-1.5 |
| pH Modifier | 0.1-1.5 |
| Viscosity Modifier | 0-1 |
| Additional functional ingredients | 0-30 |
| Water | Diluent |

TABLE 3

| | Example 1 | Example 2 | Example 3 |
|---|---|---|---|
| Description | (wt. %) | (wt. %) | (wt. %) |
| Anionic Primary Surfactant | 1-25 | 5-15 | 5-10 |
| Secondary Surfactant | 1-10 | 1-7 | 1-5 |
| Foam Booster | 1-10 | 1-7 | 1-5 |
| Solvent | 0-5 | 0-3 | 0-2 |
| Additional functional ingredient(s) | 0-10 | 0-8 | 0-2 |
| (e.g., preservative(s), skin health | | | |
| agent(s), pH adjusting | | | |
| compound(s), etc.) | | | |
| Water | Diluent | Diluent | Diluent |

The compositions can be provided in any suitable form (e.g., solid, concentrated liquid, diluted liquid) but are preferably provided as ready-to-use (RTU) foaming liquid. The compositions are preferably dispensed with a high air to product ratio. Standard dispensing pumps have a 10-15 to 1 air to product ratio. In comparison, the instant compositions preferably have an about 22-28 to 1 air to product ratio, without sacrificing cleaning efficacy or user experience.

In an embodiment, the liquid compositions provide a cleaning composition, namely a hand soap composition or hand sanitizer composition, that is mild and does not cause irritancy to skin of a user. The compositions can also be used as a foaming spray cleaner and disinfectant for hard surfaces or a foaming spot cleaner for textiles.

### Surfactant(s)

In an embodiment, the compositions include one or more surface active agents, namely surfactants. In a preferred embodiment, the compositions include a primary surfactant and a secondary surfactant. Preferably, the primary surfactant is an anionic surfactant and/or a cationic surfactant, and the secondary surfactant is a nonionic surfactant. Still more preferably, the primary surfactant is an anionic sulfate surfactant, a saturated fatty acid, an unsaturated fatty acid, and/or a cationic surfactant; and the secondary surfactant is a nonionic alkylpolyglucoside.

### Anionic Surfactants

The compositions may comprise one or more anionic surfactants. In some embodiments, the compositions comprise two anionic surfactants, preferably sulfate surfactants. Anionic surfactants are surface-active substances that are categorized as anionics because the charge on the hydrophobe is negative, or they are anionic surfactants in which the hydrophobic section of the molecule carries no charge unless the pH is elevated to neutrality or above (e.g., carboxylic acids). Carboxylate, sulfonate, sulfate, sulfolaurate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and calcium, barium, and magnesium promote oil solubility. In a preferred embodiment, the compositions include at least one anionic sulfonate surfactant.

The at least one anionic surfactant disclosed herein can be an anionic surfactant comprising at least one or more sulfate functional group (—OSO₃H or —OSO₃⁻) or at least one sulfonate functional group (—SO₃H or —SO₃), respectively.

Anionic sulfonate surfactants suitable for use in the present compositions include alkyl sulfonates, the linear and branched primary and secondary alkyl sulfonates, the aromatic sulfonates with or without substituents, and alkyl sulfolaurates. More particularly, examples of suitable anionic sulfonate surfactants include, without limitation, benzene sulfonates such as sodium dodecyl benzene sulfonate (SDBS), alkyl sulfonates, alkylamide sulfonates, alkylaryl sulfonates, α-olefin sulfonates, paraffin sulfonates, alkyl sulfosuccinates, alkyl ether sulfosuccinates, alkylamide sulfosuccinates, alkyl sulfoacetates, alkyl sulfosuccinamates, acyl isethionates, and N-acyltaurates. In an embodiment, the alkyl and acyl groups of these compounds preferably comprise from 14 to 30 carbon atoms, or from 16 to 22 carbon atoms. In an embodiment, the aryl group comprises a phenyl or benzyl group. The sulfonates may be optionally oxyethylenated and comprise from 1 to 50 ethylene oxide units.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like, including sodium lauryl sulfate (SLS also available as SULFOPON® 101 UP) and sodium laureth sulfate (SLES, also referred to as sodium lauryl ether sulfate). Also included are the alkyl sulfates, alkyl poly (ethyleneoxy) ether sulfates and aromatic poly (ethyleneoxy) sulfates such as the sulfates or condensation products of ethylene oxide and nonyl phenol (usually having 1 to 6 oxyethylene groups per molecule).

Also included are sulfolaurate anionic surfactants. Examples of suitable sulfolaurate anionic surfactants include, without limitation, alkyl sulfolaurates and salts thereof. Preferred sulfolaurates include sodium methyl 2-sulfolaurate, disodium 2-sulfolaurate, or a combination thereof.

Anionic carboxylate surfactants suitable for use in the present compositions include carboxylic acids (and salts), such as alkanoic acids (and alkanoates), ester carboxylic acids (e.g., alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates.

The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)
in which R is a C₈ to C₂₂ alkyl group or

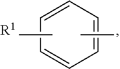

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

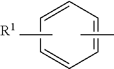

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include Neodox 23-4, a C₁₂-13 alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g., the product Sandopan® DTC, a C₁₃ alkyl polyethoxy (7) carboxylic acid.

Relatedly, the surfactant may include one or more fatty acids comprising at least one linear or branched, saturated or unsaturated hydrocarbon-based chain, such as alkyl or alkenyl, comprising at least 8 carbon atoms, preferably between 8 to 30 carbon atoms, more preferably between 10 to 22 carbon atoms, and still more preferably between 12 to 16 carbon atoms.

The fatty acid preferably has the structure R—COOH in which R denotes a linear or branched C₇-C₃₁, preferably C₉-C₂₁, and still more preferably a C₉-C₁₇ alkyl or alkenyl group. The fatty acid may also comprise an ester of a fatty acid, ethoxylated fatty acids, and other fatty acid derivatives, as described herein. Preferred fatty acids include C₁₂-C₁₆ saturated or unsaturated, branched or unbranched, substituted or unsubstituted fatty acids.

Examples of suitable fatty acids include, without limitation, lauric acid, oleic acid, linoleic acid, linolenic acid, undecylenic acid, isocetylic acid, isostearylic acid, cetylic acid, stearylic acid and cetylstearylic acid, and mixtures thereof.

The one or more anionic surfactants may be present individually or in sum an amount of between about 1 wt. % to about 30 wt. %, more preferably between about 5 wt. % and about 15 wt. % and still more preferably between about 5 wt. % and about 10 wt. %, inclusive of all integers within these ranges.

### Cationic Surfactants

Surface active substances are classified as cationic if the charge on the hydrotrope portion of the molecule is positive, if the surfactant has a positively charged functional group, and/or if the surfactant is cationically active. Surfactants in which the hydrotrope carries no charge unless the pH is lowered close to neutrality or lower, but which are then cationic (e.g., alkyl amines), are also included in this group. In theory, cationic surfactants may be synthesized from any combination of elements containing an “onium” structure RnX+Y− and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants include, for example, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

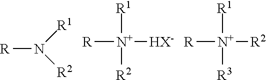

in which, R represents an alkyl chain, R′, R″, and R′″ may be either alkyl chains or aryl groups or hydrogen and X represents an anion. The amine salts and quaternary ammonium compounds are preferred for practical use in the compositions due to their high degree of water solubility.

The majority of large volume commercial cationic surfactants can be subdivided into four major classes and additional sub-groups known to those or skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkyl benzyl dimethyl ammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present disclosure include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

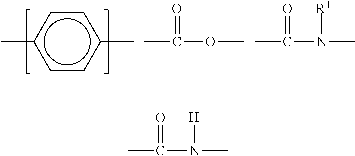

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens. Y is a group including, but not limited to:

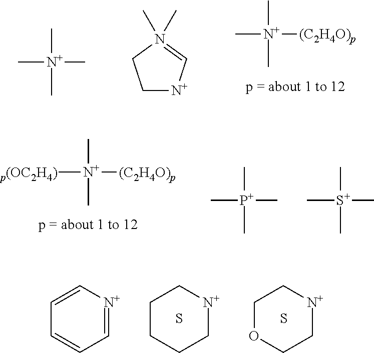

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

The one or more cationic surfactants may optionally be present in the compositions individually or in sum in an amount of between about 0.1 wt. % to about 20 wt. %, preferably between about 0.1 wt. % to about 10 wt. %, inclusive of all integers within these ranges.

### Nonionic Surfactants

In an embodiment, the compositions optionally include one or more nonionic surfactants. Nonionic surfactants are surfactants typically characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Useful nonionic surfactants include, without limitation, sugar-based surfactants, particularly glucosamides, which are formed from glucose and fatty acids. In an embodiment, the compositions include one or more glucosamides which are EO-free, sulfate-free, and/or PEG-free. The polar head group of the glucoside and glucosamide classes of surfactants are shown below. Head groups are depicted in their ring open state.

### Glucoside Polar Head Group

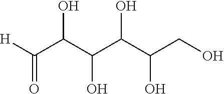 [SMILES: O=CC(O)C(O)C(O)C(O)CO]

### Glucosamide Polar Head Group

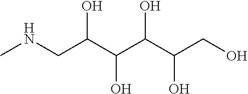

Examples of suitable glucosamides include, without limitation, capryloyl caproyl methyl glucamide, lauroyl myristoyl methyl glucamide, cocoyl methyl glucamide, sunfloweroyl methyl glucamide, coco-betaine, N-coconut acyl-N-methyl glucamine, N—C_{12/14} acyl-N-methyl glucamine, N—C_{8/10} acyl-N-methyl glucamine, or a combination thereof.

Preferred glucosamides are those having less than 18 carbons in the alkyl chain. More preferred are C₈-C₁₆ glucosamides which include. Most preferred are glucosamides having between about 8 and about 10 carbons in the alkyl chain. A particularly preferred glucosamide is capryloyl caproyl methyl glucamide, more particularly a D-Glucitol, 1-deoxy-1-(methylamino)-N—C₈-10 acyl derivative, sold commercially as GLUCOTAIN® CLEAR (50%).

An additional group of suitable nonionic surfactants includes block polyoxypropylene-polyoxyethylene polymeric compounds (EO/PO block copolymers) based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds is difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds is tetra-functional block copolymers derived from the sequential addition of propylene oxide and ethylene oxide to ethylenediamine. The molecular weight of the propylene oxide ranges from about 500 to about 7,000; and the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range, or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range, or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols are suitable. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present disclosure containing amylase or lipase enzymes because of potential incompatibility.

Examples of nonionic low foaming surfactants include:

Nonionics which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Nonionics which are modified by “capping” or “end blocking” the terminal hydroxy group or groups (of multi-functional moieties) to reduce foaming by reaction with a small hydrophobic molecule such as propylene oxide, butylene oxide, benzyl chloride; and short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959, to Brown et al. and represented by the formula

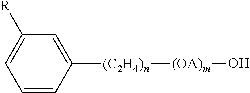

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968, to Lissant et al. having the general formula Z [(OR),OH], wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954, to Jackson et al. corresponding to the formula Y (C₃H₆O)ₙ (C₂H₄₀)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ (C₂H₄O)ₘH], wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R²CON_{R1}Z in which: R¹ is H, C₁-C₄ hydrocarbyl, 2-hydroxy ethyl, 2-hydroxy propyl, ethoxy, propoxy group, or a mixture thereof; R² is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Fatty alcohol nonionic surfactants, including ethoxylated C₆-C₁₈ fatty alcohols and C₆-C₁₈ mixed ethoxylated and propoxylated fatty alcohols and fatty alcohol polyglycol ethers. Suitable ethoxylated fatty alcohols include the C₆-Cis ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglucoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, or 6-positions on the preceding saccharide units.

Fatty acid amide surfactants suitable for use the present compositions include those having the formula: R₆CON (R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)_{X}H, where x is in the range of from 1 to 3.

A useful class of nonionic surfactants include the class defined as alkoxylated amines or, most particularly, alcohol alkoxylated/aminated/alkoxylated surfactants. These nonionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A suitable chemical of this class includes Surfonic™ PEA 25 Amine Alkoxylate. Suitable nonionic surfactants for the compositions of the disclosure include alcohol alkoxylates, EO/PO block copolymers, alkylphenol alkoxylates, and the like.

Another useful class of nonionic surfactant is alkyl polyglucosides. Alkyl polyglucosides are typically bio-based nonionic surfactants with glycoside units, i.e., alkyl polyglycosides, or polyglycerol units, and which have thickening, wetting, foaming, and/or detersive properties. Commercially available alkyl polyglucosides may contain a blend of carbon chain lengths. Examples of suitable alkyl polyglucosides include those containing carbon chain lengths of less than 16. In one example, suitable alkyl polyglucosides include C8-C16 alkyl polyglucosides and alkyl polyglucosides blends primarily containing C8-C16 or C12-C16 alkyl polyglucosides. Suitable commercially available alkyl polyglucosides include Glucopon 625 UP (lauryl/myristyl glucoside) available from BASF Corporation.

Semi-polar nonionic surfactants are another type of useful nonionic surfactants. Generally, semi-polar nonionics are high foaming and foam stabilizers. The semi-polar nonionic surfactants include the amine oxides, phosphine oxides, sulfoxides and their alkoxylated derivatives.

Amine oxides are tertiary amine oxides corresponding to the general formula

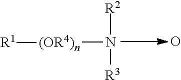

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g., through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl) amine oxide, 3,6,9-trioctadecyldimethylamine oxide and 3-dodecoxy-2-hydroxypropyldi-(2-hydroxyethyl) amine oxide.

Useful semi-polar nonionic surfactants also include the water-soluble phosphine oxides having the following structure:

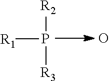

wherein the arrow is a conventional representation of a semi-polar bond; and R¹ is an alkyl, alkenyl or hydroxyalkyl moiety ranging from 10 to about 24 carbon atoms in chain length; and R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethyl hexadecyl phosphine oxide, diethyl-2-hydroxyoctyldecylphosphine oxide, bis(2-hydroxyethyl) dodecyl phosphine oxide, and bis(hydroxymethyl)tetradecyl phosphine oxide.

Semi-polar nonionic surfactants useful herein also include the water-soluble sulfoxide compounds which have the structure:

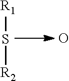

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyl dimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl) amine oxide, 3,6,9-trioctadecyldimethylamine oxide and 3-dodecoxy-2-hydroxypropyldi-(2-hydroxyethyl) amine oxide.

Suitable nonionic surfactants suitable for use with the compositions of the present disclosure include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present disclosure. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

In some embodiments, the one or more nonionic surfactants can be present in the compositions individually or in sum at an amount of between about 0.01 wt. % to about 20 wt. %, more preferably between about 0.1 wt. % to about 10 wt. %, and still more preferably between about 1 wt. % to about 5 wt. %, inclusive of all integers within these ranges.

### Amphoteric Surfactants

The compositions of the disclosure optionally include one or more amphoteric surfactants. The amphoterics can beneficially function as a foam booster and/or a secondary surfactant in the compositions of the disclosure. Amphoteric, or ampholytic, surfactants contain both a basic and an acidic hydrophilic group and an organic hydrophobic group. These ionic entities may be any of the anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” COSMETICS & TOILETRIES, Vol. 104 (2) 69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derived by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present disclosure generally have the general formula:
(mono) acetate (di) propionate

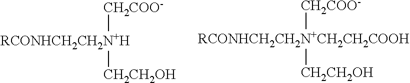

Neutral pH Zwitterion
Amphoteric Sulfonate

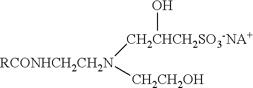

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. A particularly suitable amphoteric is disodium cocoamphodipropionate, commercially available as Mackam 2CSF.

Amphocarboxylic acids can be produced from fatty imidazolines in which the dicarboxylic acid functionality of the amphodicarboxylic acid is diacetic acid or dipropionic acid.

The carboxymethylated compounds (glycinates) described herein above frequently are called betaines. Examples of suitable betaines include long-chain betaine amphoteric surfactants. More particularly, suitable betaines include, without limitation, cocamidopropyl betaine (CAPB), cocamidopropyl betaine/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, C₁₂₋₁₆ acylmethylamidodimethylbetaine, or a combination thereof.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this disclosure include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

In some embodiments, the one or more amphoteric surfactants can be present in the compositions individually or in sum at an amount of between about 0.01 wt. % to about 20 wt. %, more preferably between about 0.1 wt. % to about 10 wt. %, and still more preferably between about 1 wt. % to about 5 wt. %, inclusive of all integers within these ranges.

### Foam Booster

The compositions may include one or more foam boosters which contribute to foam formation and/or stability. Suitable foam boosting agents include compounds that increase the volume of foam in the hand of a user. Specifically, for a foaming formulation to remain in the foam phase, bubbles in the foam must maintain their shape and volume without drainage. When drainage occurs, liquid from the outer portion or skin of the bubbles drains through the foam due to gravity and the bubbles cease to exist from the top down. As the foam volume decreases, the balance of the formulation begins pooling under the remaining foam as liquid until no more bubbles exist and liquid is all that remains.

Some examples of foam boosting agents include glyceryl caprylate/caprate sorbitan sesquicaprylate, phospholipids, phospholipid derivatives, PEG dimethicone with methyl esters, PEG-7 glyceryl cocoate, capric/caprylic monoglycerides, betaines, and combinations thereof.

The foam boosting component may also include a polymer, particular a hydrophobically modified cationic polymer obtainable from the polymerization of the following structural units: a first structural unit derived from one or more cationic ethylenically unsaturated monomers; and a second structural unit derived from one or more water-soluble monomers.

### First Structural Unit.

In an embodiment, the first structural unit is a water-soluble cationic ethylenically unsaturated monomer. The first structural unit can be a dialkyl diallyl ammonium with halides, hydrogen sulfate or methosulfate as counterions according to formula (I):

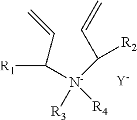

wherein: R₁ and R₂ are, independently of one another, hydrogen or C₁-C₄ alkyl; R₃ and R₄ are, independently of one another, hydrogen, alkyl, hydroxyalkyl, carboxyl alkyl, carboxyamide alkyl or alkoxyalkyl groups having from 1 to 18 carbon atoms; and Y is the counterion selected from the group consisting of chloride, bromide, iodine or hydrogen sulfate or methosulfate.

In another embodiment, the first structural unit is a quaternary or acid salt of dialkyl amino alkyl (meth) acrylate. In a further embodiment, the first structural unit is an acid salt of a dialkyl amino alkyl (meth) acrylamide or a quaternary dialkyl amino alkyl (meth) acrylamide according to formula (II):

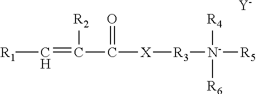

wherein: R₁ is H or C₁-C₄ alkyl; R₂ is H or methyl; R₃ is a C₁-C₄ alkylene; R₄, R₅ and R₆ are each independently H or C₁-C₃₀ alkyl; X is —O— or —NH—; and Y is Cl; Br; I;
hydrogen sulfate or methosulfate.

In one embodiment, in the cationic monomer of the formula (II): R¹ and R² are each H or Riis H and R₂ is CH₃ or preferably also H.

Suitable examples of the first structural unit are diallyl dimethyl ammonium chloride (DADMAC), (3-acrylamidopropyl)-trimethylammonium chloride (APTAC), (3-methacryl-amidopropyl)-trimethylammonium chloride (MAPTAC), dimethylaminopropylacrylat methochlorid, dimethylaminopropylmethacrylat methochlorid. Further suitable examples of the first structural unit are [2-(Acryloyloxy)ethyl]trimethylammonium chloride, also referred to as dimethylaminoethyl acrylate methochloride (DMA3*MeCl), or trimethyl-[2-(2-methylprop-2-enoyloxy)ethyl]azanium chloride, also referred as dimethylaminoethyl methacrylate methochloride (DMAEMA*MeCl). Preferably, the first structural unit is DADMAC.

### Second Structural Unit.

In an embodiment, the second structural unit is acrylamide or methacrylamide. All wt. % for each of the structural units are calculated based on 100% by weight of all structural units derived from all the monomers in the co polymer. An example of a suitable copolymer is a DADMAC/(meth) acrylamide copolymer with a molecular weight of approximately 2,000,000. Another type of suitable foam booster is cocamidopropyl PG-dimonium chloride (e.g., COLA® LIPID C).

In an embodiment, the foam booster comprises a betaine. Examples of suitable betaines include long-chain betaine amphoteric surfactants. More particularly, suitable betaines include, without limitation, cocamidopropyl betaine (CAPB), cocamidopropyl betaine/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, C₁₂₋₁₆ acylmethylamidodimethylbetaine, or a combination thereof. In a preferred embodiment, the compositions comprise a foam booster comprising a cocamidopropyl compound.

In an embodiment, the foam booster is present in the compositions in an amount of between about 0.001 wt. % to about 10 wt. %, preferably between about 1 wt. % to about 7 wt. %, and still more preferably between about 1 wt. % and about 5 wt. %, inclusive of all integers within these ranges.

### Solvent

In an embodiment, the compositions optionally include one or more solvents. In an embodiment, the solvent comprises water, an alcohol, an ester, a glycol ether, an amide, a hydrocarbon, or a combination thereof. More particularly, suitable solvents include an aromatic alcohol, alkanol amine, ether amine, glycol ether, an ester, or a combination thereof.

Examples of other suitable solvents include, without limitation, lower alkanols, lower alkyl ethers, and lower alkyl glycol ethers. Examples of such useful solvents include methanol, ethanol, propanol, isopropanol and butanol, isobutanol, ethylene glycol, diethylene glycol, triethylene glycol, propylene glycol, hexylene glycol, dipropylene glycol, mixed ethylene-propylene glycol ethers, or a combination thereof. The glycol ethers include lower alkyl (C1-8 alkyl) ethers such as propylene glycol methyl ether, propylene glycol ethyl ether, propylene glycol propyl ether, dipropylene glycol methyl ether, dipropylene glycol ethyl ether, tripropylene glycol methyl ether, ethylene glycol methyl ether, ethylene glycol ethyl ether, ethylene glycol butyl ether, diethylene glycol methyl ether, diethylene glycol butyl ether, ethylene glycol dimethyl ether, ethylene glycol monobutyl ether, or a combination thereof.

Other examples of suitable solvents include acetamido phenol, acetanilide, acetophenone, 2-acetyl-1-methylpyrrole, benzyl acetate, benzyl alcohol, methyl benzyl alcohol, alpha phenyl ethanol, benzyl benzoate, benzyloxy ethanol, ethylene glycol phenyl ether, propylene glycol phenyl ether, amyl acetate, amyl alcohol, butanol, 3-butoxyethyl-2-propanol, butyl acetate, n-butyl propionate, cyclohexanone, diacetone alcohol, diethoxy ethanol, diethylene glycol methyl ether, diisobutyl carbinol, diisobutyl ketone, dimethyl heptanol, dipropylene glycol tert-butyl ether, ethanol, ethyl acetate, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2-methyl-1-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether, tripropylene glycol n-butyl ether, diethylene glycol n-butyl ether acetate, diethylene glycol monobutyl ether, ethylene glycol n-butyl ether acetate, ethylene glycol monobutyl ether, dipropylene glycol monobutyl ether, propylene glycol monobutyl ether, ethyl 3-ethoxypropionate, 2,2,4-trimethyl-1,3-pentanediol monoisobutyrate, diethylene glycol monohexyl ether, ethylene glycol monohexyl ether, diethylene glycol monomethyl ether, diethylene glycol monoethyl ether, ethylene glycol methyl ether acetate, ethylene glycol monomethyl ether, dipropylene glycol monomethyl ether, propylene glycol methyl ether acetate, propylene glycol monomethyl ether, diethylene glycol monopropyl ether, ethylene glycol monopropyl ether, dipropylene glycol monopropyl ether, propylene glycol monopropyl ether, or a combination thereof.

One or more non-water solvent(s) may be present, individually or in sum, in an amount of between about 0 wt. % to about 10 wt. %, more preferably between about 0.1 wt. % to about 5 wt. %, and still more preferably between about 0.1 wt. % to about 2 wt. %, inclusive of all integers within these ranges. Water may be present in an amount of between about 0 wt. % to about 99 wt. %, between about 10 wt. % to about 90 wt. % and still more preferably between about 50 wt. % to about 85 wt. %, inclusive of all integers within these ranges. In some embodiments, water comprises the remainder of the composition.

### Preservative

In an embodiment, the compositions include one or more preservatives. The preservative may function to inhibit the growth of bacteria, fungi, or other microorganisms. The preservative may actively contribute to antimicrobial efficacy by itself or through interaction with other components in the compositions. In a preferred embodiment, the preservative comprises a carboxylic acid salt and/or a phenolic compound.

Examples of suitable preservatives include, without limitation, carboxylic acid salts, such as a calcium salt of a carboxylic acid, a sodium salt of a carboxylic acid, a potassium salt of a carboxylic acid, or a combination thereof. Preferred carboxylic acids include, without limitation, a salt of benzoic acid, propanoic acid, sorbic acid, methanoic acid, ethanoic acid, or a combination thereof. In an embodiment, the carboxylic acid salt preservative comprises calcium proprionate, sodium proprionate, potassium sorbate, sodium benzoate, sodium sorbate, or a combination thereof. In a still further preferred embodiment, the carboxylic acid salt is sodium benzoate.

In an embodiment, the preservative comprises a phenolic compound, halogen compound, metal derivative, amine, alkanolamine, nitro derivative, biguanide, analide, organosulfur and sulfur-nitrogen compound, alkyl paraben, isothiazolinone, or a combination thereof.

Suitable phenolic compounds include, but are not limited to, pentachlorophenol, orthophenylphenol, chloroxylenol, p-chloro-m-cresol, p-chlorophenol, chlorothymol, m-cresol, o-cresol, p-cresol, isopropyl cresols, mixed cresols, phenoxyethanol, phenoxyethylparaben, phenoxyisopropanol, phenyl paraben, resorcinol, and derivatives thereof. Suitable halogen compounds include but are not limited to iodine-poly (vinylpyrrolidin-onen) complexes, and bromine compounds such as 2-bromo-2-nitropropane-1,3-diol, and derivatives thereof. Suitable amines and nitro containing compounds include, but are not limited to, hexahydro-1,3,5-tris(2-hydroxyethyl)-s-triazine, dithiocarbamates such as sodium dimethyldithiocarbamate, and derivatives thereof. Suitable biguanides include, but are not limited to, polyaminopropyl biguanide and chlorhexidine gluconate. Suitable alkyl parabens include, but are not limited to, methyl paraben, ethyl paraben, propyl paraben, and butyl paraben. Other preservatives include, but are not limited to, phospholipid preservatives, such as triglyceride phospholipids. A suitable example is cocamidopropyl phosphatidyl PG-dimonium chloride (e.g., COLA® LIPID C).

In an embodiment, the preservative comprises an isothiazolinone, isothiazolinone blend, or other preservative in the isothiazolinone family. Examples of isothiazolinone blends include Kathon CG-ICP which is a 3:1 blend of 5-Chlor-2-methyl-4-isothiazolin-3-one and 2-Methyl-4-isothiazolin-3-one (CMIT/MIT). Examples of isothiazolinone compounds in the family include, without limitation, chloromethylisothiazolinone, methylisothiazolinone, isothiazolinone derivatives, 5-chloro-2-methyl-4-isothiazolin-3-one (CMIT), 2-methyl-4-isothiazolin-3-one (MIT), 1,2-benzisothiazolin-3-one (BIT), 2-bromo-2-nitro-propane-1,3-diol (Bronopol), a long chain quaternary ammonium compound, an aliphatic diamine, a guanidine, biguanidine, n-dodecylguanidine hydrochloride (DGH), n-alkyl dimethyl benzyl ammonium chloride, didecyl dimethyl ammonium chloride, 1,2-dibromo-2,4-dicyanobutane, 2,2-dibromo-3-nitrilopropionamide (DBNPA), bis(trichloromethyl) sulfone, 4,5-dichloro-1,2-dithiol-3-one, 2-bromo-2-nitrostyrene, 5-chloro-2-methyl-4-isothiazolin-3-one (CMIT), and 2-methyl-4-isothiazolin-3-one (MIT).

One or more preservatives may optionally be present, individually or in sum, in an amount of between about 0 wt. % to about 10 wt. %; or when present, between about 0.025 wt. % to about 5 wt. %, and still more preferably between about 0.025 wt. % to about 2 wt. %, inclusive of all integers within these ranges.

### pH Modifier

The compositions optionally include a pH modifier or pH adjusting agent. In some instances, a pH adjusting compound may be utilized to provide a desired composition or ready-to-use solution pH. In an embodiment, the compositions will have a pH of between about 2 to about 10, more preferably between about 4 to about 9.5.

Examples of basic pH-adjusting compounds include, but are not limited to, ammonia; mono-, di-, and trialkyl amines; mono-, di-, and trialkanolamines; alkali metal and alkaline earth metal hydroxides; alkali metal phosphates; alkali sulfates; alkali metal carbonates; and mixtures thereof. However, the identity of the basic pH adjuster is not limited, and any basic pH-adjusting compound can be used. Specific, nonlimiting examples of basic pH-adjusting compounds are ammonia; sodium, potassium, and lithium hydroxide; sodium and potassium phosphates, including hydrogen and dihydrogen phosphates; sodium and potassium carbonate and bicarbonate; sodium and potassium sulfate and bisulfate; monoethanolamine; trimethylamine; isopropanolamine; diethanolamine; and triethanolamine.

Examples of suitable acidic pH-adjusting compounds include, but are not limited to, carboxylic acids, mineral acids and polycarboxylic acids, including aminocarboxylic acids. Nonlimiting examples of mineral acids are hydrochloric acid, nitric acid, phosphoric acid, and sulfuric acid. Some examples of aminocarboxylates include N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), and the like. Suitable carboxylic acids include, without limitation, lactic acid, glycolic acid, citric acid, acetic acid, formic acid, oxalic acid, uric acid, malic acid, tartaric acid, gluconic acid, glucaric acid, ascorbic acid, glutamic acid, levulinic acid, heptanoic acid, octanoic acid, nonanoic acid, decanoic acid, dodecanoic acid, tetradecanoic acid, hexadecenoic acid, octadecanoic acid, benzoic acid, icosanoic acid, or a combination thereof.

The compositions can include a pH modifier in an amount of about 0 wt. % to about 5 wt. % or about 0.1 wt. % to about 2 wt. %, inclusive of all integers within these ranges.

### Viscosity Modifier

Viscosity modifiers can be optionally used to increase or decrease the viscosity of the compositions. The one or more viscosity modifiers may be used to obtained a desired viscosity, for example less than 150 cp, more preferably less than 100 cp, and still more preferably less than 50 cp. Example viscosity modifiers include, but are not limited to, inorganic salts (sodium chloride, sodium sulfate, magnesium sulfate, etc.), polymers (polyacrylates, cellulose derivatives, etc.), gums (guar and guar derivatives, xanthan, etc.), inorganic salts (calcium chloride, etc.) and organic solvents (alcohols, glycol ethers, etc.). The compositions can include a viscosity modifier in an amount of about 0 wt. % to about 5 wt. % or about 0.1 wt. % to about 1 wt. %, inclusive of all integers within these ranges.

### Dermal Adjuvants/Skin Health Agents

The composition can contain one or more dermal adjuvants/skin health agents. The terms dermal adjuvant and skin health agent are herein used interchangeably and generally include any substance which improves or maintains the health of the epidermis. Some examples include but are not limited to emollients, skin conditioners, humectants, occlusive agents, antioxidants, vitamins, nutrients, moisturizers, or a combination thereof.

The composition can include emollients including but not limited to dicaprylyl carbonate, dibutyl adipate, hexyl laurate, dicaprylyl ether, propylheptyl caprylate. Also included are ethoxylated natural and synthetic oils. Examples include C12-15 alkyl benzoate, capric triglyceride, caprylic triglyceride, isopropyl myristrate, isopropyl palmitate, octyldodecanol, decyl oleate, cocoglycerides, ethylhexyl stearate, ceteraryl isononanoate, cetearyl ethyhexanonate, decyl cocoate, cetyl dimethicone, ethylhexyl palmitate, PPG-11 stearyl ether, PPG-15 stearyl ether, and PPG-14 butyl ether.

These materials also may include derivatives of water soluble oils and waxes, ethoxylated fats and oils, lanolin ethoxylate; examples include mono-, di-, and tri-glycerides and butters and hydrogenated versions of seed and nut oils including but not limited to; palm oil, coconut oil, vegetable oil, avocado oil, canola oil, corn oil, soy bean oil, sunflower oil, safflower oil, meadowfoam seed oil, bilberry seed oil, watermelon seed oil, olive oil, cranberry, macadamia nut oil, argan oil, pomegranate oil, argan Moroccan oil, blue berry oil, raspberry oil, walnut oil, pecan oil, peanut oil, bayberry oil, mango seed oil, Marula oil, castor oil, Shea butter, jojoba oil, hydrolyzed jojoba oil, Carnauba butter, Carnauba wax, castor isostearate succinate stearyl heptanoate, cetyl ricinoleate, oleyl erucate, sucrose monostearate, sucrose distearate, sucrose tristearate, sucrose tetrastearate, cetyl alcohol, lanolin, lanolin ethoxylate, low molecular weight polyethylene waxes, lower molecular weight polypropylene waxes, PEG-30 glyceryl cocoate, PEG-80 Glyceryl cocoate, PEG-30 Glyceryl stearate, PEG-8 Ricinoleate, PEG-8 Raspberriate, Linear (otherwise known as bis) and Pendant versions of including hydroxyl terminated and methyl ether terminated; PEG-3 to PEG-32 Dimethicone (including but not limited to: PEG-3 Dimethicone, PEG-8 Dimethicone, PEG-9 Dimethicone, PEG-10 Dimethicone, PEG-11 Methyl ether dimethicone, PEG-12 Dimethicone, PEG-14 Dimethicone, PEG-17 Dimethicone, PEG-32 Dimethicone), bis-PEG/PPG-20/20 Dimethicone, PEG/PPG 20/23 Dimethicone, PEG/PPG 20/22 Butyl Ether Dimethicone, PEG/PPG 23/6 Dimethicone, PEG/PPG 20/15 Dimethicone.

Alkyl modified dimethicone (stearoxy dimethicone, behenoxy dimethicone, cetyl dimethicone, certeryl methicone C30-45 Alkyl cetearyl dimethicone copolymer, C30-45 Alkyl dimethicone, caprylyl methicone, PEG-8 dimethicone/dimer dilinoleic acid copolymer, Bis-PEG-10 Dimethicone/Dimer Dilinoleate Copolymer, Stearoxymethicone/Dimethicone Copolymer, Dipheyl dimethicone, Lauryl polyglycerol-3 polydimethylsiloxyethyl dimethicone, Lauryl PEG-9 polydimethylsiloxyethyl dimethicone), Dimethicone fluid (>20 cst), quaternized ammonia silicone polymers, Amino silicones, silicone quaternium-18, Amodimethicone, phenyltrimethicone, amino silicone polyethers, Polyglycerol-3 Disiloxane dimethicone, Polyglycerol-3 polydimethylsiloxyethyl dimethicone, and PEG-9 polydimethylsiloxyethyl dimethicone.

The composition can include one or more skin conditioners to provide skin moisturization, skin softening, skin barrier maintenance, anti-irritation, or other skin health benefits. Some non-limiting examples of additional skin conditioners include cationic and nonionic guar and their derivatives, alkyl benzoate, myristyl myristate, cetyl myristate, gelatin, lactic acid, glyceryl dioleate, methyl laurate, PPG-9 laurate, lauryl lacylate, allantoin, octyl palmitate, lanolin, propylene glycol, butylene glycol, ethylene glycol, caprylyl glycol, monobutyl ether, glycerin, fatty acids, proline, natural oils such as almond, mineral, canola, sesame, soybean, pyrrolidine, wheat germ, hydrolyzed wheat protein, hydrolyzed oat protein, hydrolyzed collagen, corn, peanut and olive oil, isopropyl myristate, myristyl alcohol, aloe vera, algae extract, cocamidopropyl PG dimmonium chloride phosphate, gluconic acid, hydrolyzed silk protein, 1,3-propane-diol, Vitamin E, niacinamide, stearyl alcohol, isopropyl palmitate, sorbitol, amino acid complexes, panthenol, Cocoamidopropyl PG Dimonium Chloride, quaternized hydrolyzed protein such as collagen, oat, wheat, inositol, fructose, sucrose, hydrolyzed plant proteins, seaweed extract, polyethylene glycol, ammonium lactate, sodium hyaluronate, and cyclic peptides.

Some non-limiting examples of humectants include hydroxyethyl urea, agarose, urea, fructose, glucose, glutamic acid, glycerin, honey, lactose, maltose, polyethylene glycol, sorbitol and mixtures thereof.

Some non-limiting examples of occlusive agents include ethoxylated petrolatum, ethoxylated version of shea butter, avocado oil, balm mint oil, cod liver oil, mineral oil, trimyristin, stearyl stearate, synthetic wax, or mixtures thereof.

Some non-limiting examples of moisturizers include ethyl hexylglycerin, cholesterol, cystine, hyaluronic acid, keratin, lecithin, egg yolk, glycine, PPG-12, polyquaternium polymers such as polyquaternium-11, behentrimonium chloride, dihydroxypropyl PEG-5 linoleammonium chloride, glycerol oleate, PEG-7 glyceryl cocoate, cocoglucoside, PEG-200 hydrogenated glyceryl palmate, panthenol, retinol, salicylic acid, vegetable oil, methyl gluceth-10, methyl gluceth-20, ethoxylated derivatives of skin conditioners such as glycereth-26 and ethoxylated shea butter, and mixtures thereof. Finally, some non-limiting examples of compounds that also function as anti-irritants include bisabolol and panthenol.

The skin health agent may comprise an antioxidant for improved skin condition through the removal of free radicals, and improved product stability. Some non-limiting examples of antioxidants include retinol and retinol derivatives, ascorbic acid and ascorbic acid derivatives, BHA, BHT, beta carotene, cysteine, erythorbic acid, hydroquinone, tocopherol and tocopherol derivatives, and the like.

When present, the one or more skin health agents may be present individually or in sum in an amount of from about 0.01 wt. % to about 15 wt. %, preferably from about 0.01 wt. % to about 10 wt. % and more preferably from about 0.01 wt. % to about 2 wt. %, inclusive of all integers within these ranges.

### Additional Functional Ingredients

The compositions optionally can further be combined with one or more additional functional ingredients. The functional ingredients provide desired properties and functionalities to the compositions. For the purpose of this application, the term “functional ingredient” includes a material that when dispersed or dissolved in a use or concentrate solution, such as an aqueous solution, provides a beneficial property in a particular use. Some particular examples of functional materials are discussed in more detail below, although the particular materials discussed are given by way of example only, and that a broad variety of other functional ingredients may be used

Additional functional ingredients may include further defoaming agents, bleaching agents or optical brighteners, solubility modifiers, buffering agents, dye transfer inhibiting agents, dispersants, stabilizing agents, sequestrants or chelating agents to coordinate metal ions and control water hardness, microbial synergists, fragrances, dyes/colorants, rheology modifiers or thickeners, hydrotropes or couplers, buffers, solvents, pH buffers, colorants, and the like.

### Colorant

The compositions can optionally comprise a colorant. Preferred colorants include natural and synthetic colorants or dyes. Most preferably the colorant comprises FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), F&C Red 33, Fluorescein (Capitol Color and Chemical), Acid Green 25 (Ciba-Geigy), or a combination thereof.

In an aspect, the colorant or dye may comprise dyes which are generally recognized as safe. Suitable dyes include, but are not limited to, FDC Blue #1, FDC Blue #2, FDC Green #3, FDC Red #3, FDC Red #4, FDC Red #40, Violet #1, FDC Yellow #5, and FDC Yellow #6.

### Antimicrobial Agents

In some embodiments, the compositions can optionally include an antimicrobial or sanitizing agent. Sanitizing agents, also known as antimicrobial agents, are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

Some examples of common antimicrobial agents include phenolic antimicrobials such as pentachlorophenol, orthophenylphenol, chloro-p-benzylphenol, p-chloro-m-xylenol. Halogen containing antibacterial agents include sodium trichloroisocyanurate, sodium dichloro isocyanate (anhydrous or dihydrate), iodine-poly (vinylpyrolidinone) complexes, bromine compounds such as 2-bromo-2-nitropropane-1,3-diol, and quaternary ammonium compounds, such as benzalkonium chloride, didecyldimethyl ammonium chloride, dialkyl dimethyl ammonium chloride, alkyl dimethyl benzyl ammonium chloride, choline diiodochloride, tetramethyl phosphonium tribromide, or a combination thereof.

Other suitable antimicrobial agents include, for example, hexahydro-1,3,5-tris(2-hydroxyethyl)-s-triazine, dithiocarbamates such as sodium dimethyldithiocarbamate, chloroxylenol also known as Para-Chloro-Meta-Xylenol,

Cationic actives may also be used in the compositions. The cationic active ingredients are generally cationic substances based on nitrogen centered cationic moieties with a net positive change. The cationic actives include, for example, cationic polymers, cationic surfactants, cationic monomers, cationic silicon compounds, cationic derivatized protein hydrolyzates and betaines with at least one cationic or cationically active group.

Suitable cationic actives preferably contain quaternary ammonium groups. Suitable cationic active ingredients especially include those of the general formula:

N⁽⁺⁾R¹R²R³R⁴X⁽⁻⁾

wherein R¹, R², R³ and R⁴ independently of each other represent alkyl groups, aliphatic groups, aromatic groups, alkoxy groups, polyoxyalkylene groups, alkylamido groups, hydroxyalkyl groups, aryl groups, H⁺ ions, each with from 1 to 22 carbon atoms, with the provision that at least one of the groups R¹, R², R³ and R⁴ has at least eight carbon atoms and wherein X(−) represents an anion, for example, a halogen, acetate, phosphate, nitrate or alkyl sulfate, preferably a chloride. The aliphatic groups can also contain cross-linking or other groups, for example additional amino groups, in addition to the carbon and hydrogen atoms. Particular cationic actives include, but are not limited to, alkyl dimethyl benzyl ammonium chloride (ADBAC, or benzalkonium chloride), alkyl dimethyl ethylbenzyl ammonium chloride, dialkyl dimethyl ammonium chloride, benzethonium chloride, N, N-bis-(3-aminopropyl) dodecylamine, chlorhexidine gluconate, a salt of chlorhexidene gluconate, PHMB (polyhexamethylene biguanide), salt of a biguanide, a substituted biguanide derivative, an organic salt of a quaternary ammonium containing compound or an inorganic salt of a quaternary ammonium containing compound or mixtures thereof. Suitable cationic actives can also include surfactants that are cationic in certain conditions, e.g., in acidic media, such as lauryl dimethyl amine oxide, myristyl dimethyl amine oxide, cetyl dimethyl amine oxide, or a combination thereof.

Antimicrobial active can optionally be present in the compositions in an amount of between about 0.01 wt. % to about 10 wt. %, and preferably about 0.05 wt. % to about 5 wt. %, and more preferably from about 0.1 wt. % to about 2 wt. % of the composition, inclusive of all integers within these ranges.

### Methods of Dispensing

In an aspect, the disclosure involves methods of dispensing the compositions described herein, particularly insofar as the method of dispensing is utilized as a step in a method of treating a tissue or a surface. In some methods of dispensing, the compositions described herein are loaded into a dispensing apparatus, preferably a hand soap dispensing pump.

The dispensing apparatus may be any suitable apparatus capable of dispensing liquids and particularly foam. Examples of such apparatuses are well known. For example, such apparatuses may include a fluid containing reservoir, a dispensing mechanism which, on activation, causes fluid to be discharged from the from the reservoir, and an activation mechanism for activation of the dispensing mechanism by movement of the activation mechanism, wherein the activation mechanism is adapted for engagement by a user to move the activation mechanism. The activation mechanism may be engaged either manually or through the use of a sensor. For example, for manual activation, the dispensing apparatus may comprise a fluid containing reservoir, a dip tube, a piston mechanism comprising a spring, a pump body, a lower piston rod, a pump plug, a cap, a gasket, a locking cap, and an upper piston rod, as well as a pump head, wherein the pump head is manually activated by a user, and the interaction between the pump head and piston mechanism draws the liquid from the reservoir through the pump head. Alternatively, the dispenser may be an electric or battery-operated “automatic” dispenser, wherein the activation mechanism is activated by the presence of a user's hand through use of a sensor, such as an infrared sensor, capacitive sensor, or light sensor.

In an aspect, the methods of dispensing comprise (a) providing a dispensing device comprising a fluid reservoir comprising a fluid, a pump, a pump head, and a pump activation mechanism, (b) moving the activation-mechanism to move the fluid from the fluid reservoir and out the pump head, thereby dispensing the fluid in a predetermined minimum dose volume, dose density, and air to product ratio.

In an embodiment, the predetermined minimum dose volume is between about 0.3 ml to about 1.0 ml of the composition, and preferably between about 0.3 ml to about 0.8 ml, and still more preferably between about 0.5 ml to about 0.6 ml.

In an embodiment, the fluid has a viscosity of less than 50 Cp·s.

In an embodiment, the fluid has a predetermined density of between about 18 ml/g to about 27 ml/g, more preferably between about 18 ml/g to about 25 ml/g, and still more preferably between about 18 ml/g to about 22 ml/g.

### Methods of Treating a Tissue or Surface

In an aspect, the present disclosure is directed to a method for treating a surface or a tissue, which method comprises contacting a surface or a tissue with an effective amount of the compositions, wherein the contacting step lasts for sufficient time to stabilize or reduce a microbial population on the surface or target.

In a further embodiment, methods of cleaning a skin surface are provided, wherein the method comprises contacting the cleaning compositions disclosed herein to the skin surface/tissue, wherein the contacting lasts for a sufficient time to stabilize or reduce a microbial population on the surface. In an embodiment, the skin surface is from a mammal. In a still further embodiment, the skin surface is from a non-human animal.

In an embodiment, the microbial population is a gram positive or gram negative bacteria, a fungus, a virus, or a combination thereof. In a further embodiment, the microbial population comprises Escherichia coli, Pseudomonas aeruginosa, Staphylococcus aureus, methicillin-resistant Staphylococcus aureus (MRSA), Candida albicans, Salmonella enterica, Listeria monocytogenes, a human calicivirus (HuCV) a norovirus, or a combination thereof.

In some embodiments the methods further comprise a rinsing step, wherein the surface to be cleaned is rinsed after the surface is contacted with the composition.

The contacting step may last for a suitable period of time, for example at least about 10 seconds and up to several hours. More preferably, the contacting lasts for a period of between about 10 seconds to about 3 hours, between about 20 seconds to about 1 hour, or between about 30 seconds to about 30 minutes.

The contacting preferably reduces or eliminates one or more microbes or a microbial population. In an embodiment, the composition provides an at least 2 log₁₀ reduction in a microbial population, an at least 3 log₁₀ reduction in a microbial population, an at least 4 log 10 reduction in a microbial population, or an at least 5 log₁₀ reduction in a microbial population.

### EXAMPLES

Embodiments of the present disclosure are further defined in the following non-limiting Examples. It should be understood that these Examples, while indicating certain embodiments, are given by way of illustration only. From the above discussion and these Examples, one skilled in the art can ascertain essential characteristics, and without departing from the spirit and scope thereof, can make various changes and modifications of the embodiments adapt it to various usages and conditions. Thus, various modifications of the embodiments, in addition to those shown and described herein, will be apparent to those skilled in the art from the foregoing description. Such modifications are also intended to fall within the scope of the appended claims.

### Example 1

Compositions according to the disclosure were prepared according to Table 4 and evaluated for foam appearance.

TABLE 4

| | EXP | EXP | EXP | EXP | EXP | EXP | EXP | EXP |
|---|---|---|---|---|---|---|---|---|
| | 27 | 41 | 30 | 28 | 34 | 31 | 32 | 33 |
| Component | (wt. %) | (wt. %) | (wt. %) | (wt. %) | (wt. %) | (wt. %) | (wt. %) | (wt.%) |
| Water | 80-85 | 80-85 | 75-80 | 80-85 | 85-90 | 85-90 | 75-85 | 55-65 |
| Sodium Laureth | 8-10 | 8-10 | | | 5-7 | 5-10 | | |
| Sulfate, 70% | | | | | | | | |
| Sodium Lauryl | | | 11-15 | | | | 1-5 | |
| Sulfate, 30% | | | | | | | | |
| Sodium Xylene | | | | | | | | 1-5 |
| Sulfonate, 40% | | | | | | | | |
| Alkylpolyglucoside, | 1-2 | 1-2 | 3-4 | | 1-3 | | | |
| 50% | | | | | | | | |
| Cocamidopropyl | 1-4 | 1-4 | 1-4 | 1-2 | 1-3 | | | |
| Betaine, 30% | | | | | | | | |
| Hexylene Glycol | 0.5-1.5 | | | | 0.1-1 | | 1-5 | |
| Propylene Glycol | | | 0.1-0.5 | | | | | |
| Potassium Cocoate | | | | 7-10 | | | 3-7 | 2-5 |
| Potassium Stearate | | | | 0.5-1 | | | | |
| Lauryl Dimethyl | | | | 0.5-1 | | | | 0.1-1 |
| Amine Oxide | | | | | | | | |
| Ethanol | | | | 1-3 | | | | 1-3 |
| C12-C16 Fatty | | | | | 1-5 | | | |
| Alcohol Polygly- | | | | | | | | |
| coside | | | | | | | | |
| PEG Glyceryl | | | | | 1-5 | | | |
| Cocoate | | | | | | | | |
| C12-C14 Fatty | | | | | 0.5-1.5 | | | |
| Alcohol (2.5 EO) | | | | | | | | |
| Coco Glucoside/ | | | | | | | 0.1-1 | |
| Glyceryl Oleate | | | | | | | | |
| Antimicrobial | | | | | | | 0.5-1.3 | 1-3 |

The formula of Exp. 28 was loaded into hand soap dispensing pumps. Exp. 28 was loaded into a first pump at a dose of approximately 1 ml with a lower air to product ratio of about 10-15 to 1, which is standard in the industry (“Product A”). Exp. 28 was also loaded into a pump at a lower dose of approximately 0.6 ml and a higher air to product ratio (“Product B”). 1 pump of each product was dispensed and placed in a dish. Users were requested to evaluate whether Product A or Product B was larger in size, or whether the two dispensed products were the same size. The results are shown in Table 5 below.

TABLE 5

| Option | No. of Votes |
|---|---|
| Product A is bigger than Product B | 16 |
| Products A and B are the same size | 20 |
| Product B is bigger than A | 17 |

These findings demonstrate that that the compositions of the disclosure, when dispensed a higher product to air ratio, results in an unaffected appearance of the foam. This is critical since a lower foam volume or modified foam appearance would encourage users to dispense multiple doses in assumption of ensuring an ample supply of product for proper handwashing.

### Example 2

The formula of EXP 27 was loaded into hand soap dispensing pumps. EXP 27 was loaded into the first pump at a dose of approximately 1 ml with a lower air to product ratio of about 10-15 to 1, which is standard to industry (“Product A”). EXP 27 was also loaded into a pump at a lower dose of approximately 0.6 ml and a higher air to product ratio (“Product B”).—each were dispensed into a dish. Another commercially available hand soap (Rubber Maid's Enriched Foam Hand Soap) was similarly dispensed for use as a control composition (“Product C”). Product C is marketed as having a high density foam and is delivered in a concentration of approximately 0.4 ml. Users were asked to answer two questions: (1) which product had more foam, and (2) which product had enough foam for proper handwashing without needing multiple doses. The results are shown in Table 6 below.

TABLE 6

| | Product A vs. | Product B vs. |
|---|---|---|
| | Product B | Product C |
| Question # 1 | A = 6 | B = 30 |
| | B = 10 | C = 0 |
| | Equal = 14 | Equal = 0 |
| Question # 2 | A = 7 | B = 25 |
| | B = 8 | C = 3 |
| | Equal = 15 | Equal = 2 |

As shown in Table 6, 33% of users thought Product B had more foam than Product A. 47% thought Product A and B had equal foam. 50% of participants thought Product B and Product B had enough foam for proper handwashing without needing multiple doses from dispenser. 100% of participants thought Product B had more foam than Product C. 83% of participants thought Product C has enough foam for proper handwashing without needing multiple doses from a dispenser.

These findings confirm that the appearance of foam is critical for users to maintain a handwashing experience without the need for multiple products dispense and further confirm that the compositions of the present disclosure provide satisfactory foam volume and size, event at lower concentrations.

### Example 3

In hand soap products, the desired foam characteristics should aim to provide an effective and satisfying handwashing experience for users. One of the descriptions of the desired foam experience is foam density. Foam density refers to the concentration of material/product within a given volume of foam. It measures how much mass is present in the foam relative to the space it occupies. Foam with too low of a density might feel too airy and lightweight, leading to difficulties in applying and distributing the product effectively. It may also lack the desired coverage, making it less efficient for its intended use. Additionally, users might find it challenging to control and apply the foam as it could dispense too quickly. On the other hand, if the foam has too high of a foam density, it can result in a foam that feels overly heavy and difficult to dispense, potentially causing strain on the foam dispenser's mechanisms. unusually high density of foam could also result in an excessive amount of product being used to achieve the desired coverage, leading to wastage and higher costs for users. The ideal foam density should strike a balance between being lightweight enough for easy dispensing application, while still having substance to effectively cover the desired area. This balance ensures that users can achieve the desired results without feeling like they need to use too much product or need to repeatedly dispense more to properly wash hands.

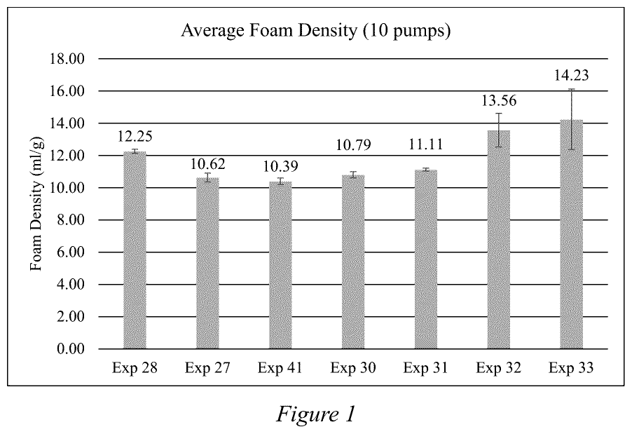

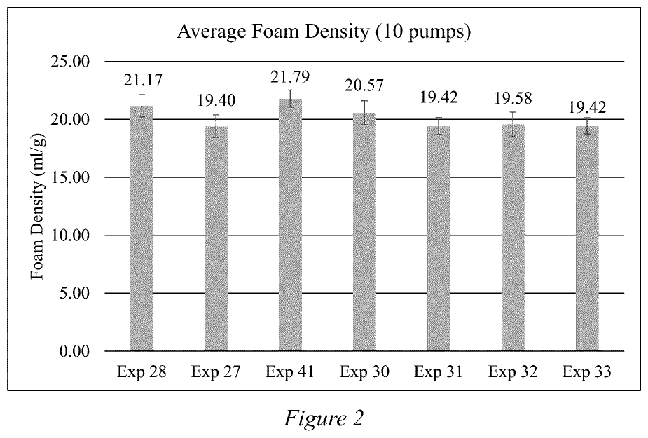

The formulations of Table 4 were prepared consistent with Example 1. The foam profile of these formulations was evaluated in comparison to several commercially available control compositions. The results are shown in Tables 7-8 and FIGS. 1-2.

TABLE 7

| Product (Pump A) | Avg. Foam Density (ml/g) | CI (95%) |
|---|---|---|
| Exp. 28 | 12.25 | 0.13 |
| Exp. 27 | 10.62 | 0.28 |
| Exp. 41 | 10.39 | 0.21 |
| Exp. 30 | 10.79 | 0.19 |
| Exp. 31 | 11.11 | 0.10 |
| Exp. 32 | 13.56 | 1.17 |
| Exp. 33 | 14.23 | 1.48 |

TABLE 8

| Product (Pump B) | Avg. Foam Density (ml/g) | CI (95%) |
|---|---|---|
| Exp. 28 | 21.17 | 0.97 |
| Exp. 27 | 19.40 | 0.99 |
| Exp. 41 | 21.79 | 0.74 |
| Exp. 30 | 20.57 | 1.04 |
| Exp. 31 | 19.42 | 0.74 |
| Exp. 32 | 19.58 | 1.25 |
| Exp. 33 | 19.42 | 0.79 |

Based on the data in Tables 7-8, preferred foam density ranges from about 18-27 ml/g, more preferably between about 18-25 ml/g and still more preferably between about 18-22 ml/g. The Rubbermaid chemistry marketed as a concentrated formulas and high-density foam delivers a density of 17.70 ml/g, which does not fall within the most preferred density range.

### Example 4

In addition to visual appearance and adequate foam density, the ability of a hand soap to effectively remove soil from hands is a fundamental tool for maintaining personal hygiene. A foaming hand soap dispensed from a proper dispenser should efficiently remove soil with a single application, eliminating the need for further product dispensation. This strong performance guarantees hygiene and reinforces user confidence.

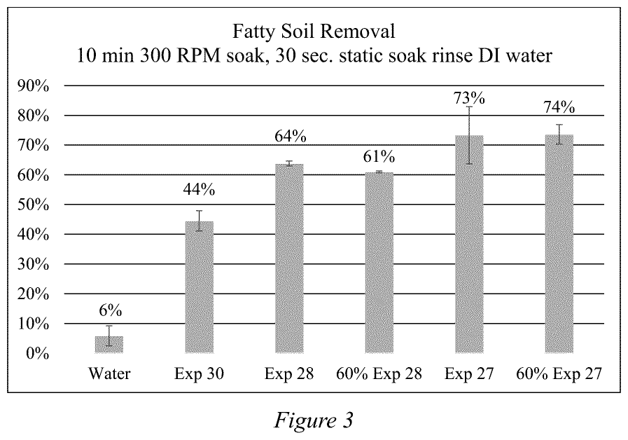

The cleaning capabilities of the compositions were evaluated. Specifically, the hand soap formulations were evaluated for their fatty soil removal performance. A fatty soil mixture comprising shortening was applied onto test coupons with a foam brush. The coupons were allowed to cure overnight to ensure the fatty soil was adhered to the test surface. The formulations of Table 3 were prepared and poured into shallow trays. The soiled coupons were then placed into the shallow trays and allowed to soak for 10 minutes. After 10 minutes, the coupons were removed and rinsed for 30 seconds. The cleaned coupons were then allowed to dry. Soil removal was then calculated using the following formula:

$$\frac{{W}_{S} - {W}_{A}}{{W}_{S} - {W}_{B}} \times 100 = soil removal$$

Wherein Wₛ refers to the coupon and soil only, Wₐ refers to the coupon and soil after cleaning, and W_{b} refers to the coupon only. The results are shown in FIG. 3. As shown in FIG. 3, the compositions of the disclosure provide improved soil removal compared to comparable commercial formulations. In particular, even the compositions at a lower concentration (60%) provide improved soil removal capabilities compared to the controls.

### Example 5

The formulations of Table 3 were again prepared consistent with Example 1. The foam profile of these formulations was evaluated in comparison to several commercially available control compositions. The analysis was conducted using a SITA foam analyzer, evaluating 250 ml the formulations of Example 1 at 800 RPM stirring rate. Some formulations were diluted to between 40%-60% of their concentrations for purposes of testing. Foam was evaluated every 10 seconds with 99 readings made. The SITA analyzers assesses foam build-up (the measure of foam volume over time) and foam decay.

Samples of the relevant formulations were placed in the SITA analyzer. The SITA tester creates foam through an automated stirring mechanism and uses sensors to measure volume, foam structure, and foam decay. The results are shown in Table 9.

TABLE 9

| | Time of peak | Peak rate of | |
|---|---|---|---|
| Formula and | foam generation | foam generation | Foam Height |
| Concentration | (seconds) | (ml/s) | @ 20s (ml) |
| 60% of Exp. 28 | 425 | 9.99 | 198 |
| 60% of Exp. 27 | 615 | 9.5 | 201 |
| 60% of Exp. 41 | 645 | 9.75 | 174 |
| 40% Rubbermaid | 595 | 9.75 | 172 |
| 60% of Exp. 34 | 707 | 10 | 185 |
| 60% of Exp. 30 | 633 | 9.49 | 179 |
| 60% of Exp. 32 | 665 | 8.88 | 197 |
| 60% of Exp. 33 | 530 | 9 | 197 |
| Exp. 28 | 263 | 9.5 | 200 |
| Exp 27 | 380 | 9.8 | 189 |
| Exp 41 | 400 | 9.875 | 178 |
| Exp. 30 | 330 | 9.75 | 185 |
| Exp. 34 | 560 | 10.2 | 183 |
| Exp. 33 | 220 | 9.35 | 203 |
| Exp. 32 | 215 | 9.09 | 206 |

The results indicate that formulations of the disclosure generate equal foam height at 20 seconds at 60% dilution (60% dilution simulates a pump out of a product at 0.6 ml).

### Example 6

The viscosity of the compositions was next evaluated. Viscosity plays a crucial role in insuring that foaming hand soap can be effectively dispensed as a foam while maintaining a visually pleasing appearance. The right viscosity level allows the soap to flow smoothly through the dispenser, creating a well-formed and stable foam that users find satisfactory in terms of both texture and visual appeal. The results are shown in Table 10.

TABLE 10

| | | Salt | Can | | |
|---|---|---|---|---|---|
| | | concent- | dispense | | Viscosity |
| Formu- | | ration | with a | Viscosity | measurement |
| lation | Surfactant(s) | (%) | pump | (Cp · s) | condition |
| EXP 27 | SLES, | None | Yes | 14.8 | Spindle 1, rpm |
| | Betaine, APG | | | | 100, 77 F. |
| EXP 28 | Potassium | None | Yes | 16.8 | Spindle 1, rpm |
| | Cocoate + | | | | 100, 77 F. |
| | Potassium | | | | |
| | Stearate | | | | |
| EXP 30 | SLES, | None | Yes | 18.5 | Spindle 1, rpm |
| | Betaine, APG | | | | 100, 77 F. |
| EXP 27 | SLES, | 1.95 | No (not | 138 | Spindle 63, rpm |
| | Betaine, APG | | acceptable) | | 100, 77 F. |

Based on the table above, for the foaming hand soaps of the disclosure to be dispensed most effectively using a pump with a high product to air ratio, the viscosity of the compositions is preferably less than 150 Cp·s and still more preferably less than 50 Cp·s.

### Example 7

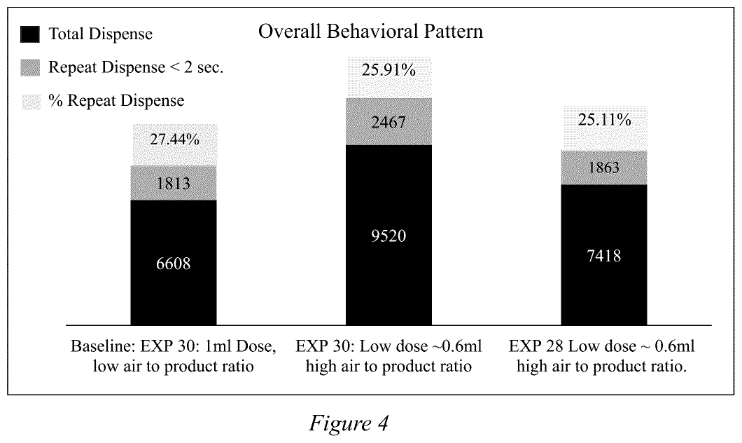

Internally, 14-16 soap dispensers in select restrooms were connected to a gateway that collects activation information. The first phase of the trial was conducted using Exp. 30 at a high dose with a high product to air ratio. The second phase evaluated Exp. 30 with a 0.6 ml dose at a high product to air ratio. The final phase evaluated Exp. 28 at a 0.6 ml dose and a high product to air ratio, as shown in Table 11. Each phase trial lasted a minimum of 30 days. The dispenser stayed the same for all phases of the trial although the formulation with was switched depending on the trial phase. The results are shown in FIG. 4.

As shown in FIG. 4, overall user behavior in terms of total product dispensed and repeat dispensing activity did not significantly differ between the control formulations and the formulations of the disclosure. This beneficially demonstrates that the compositions of the disclosure provide substantially similar user experience and performance even at a lower concentration of product.

### Example 8

Next, a sensory panel test was performed to understand users' acceptability of the foaming hand soaps of the present disclosure, when dosed at a lower volume with a high product to air ratio. Users were recruited to wash their hands and evaluate product performance. Users were asked to identify their preferred product between Exp. 27 as shown in Example 1 and control/competitor products.

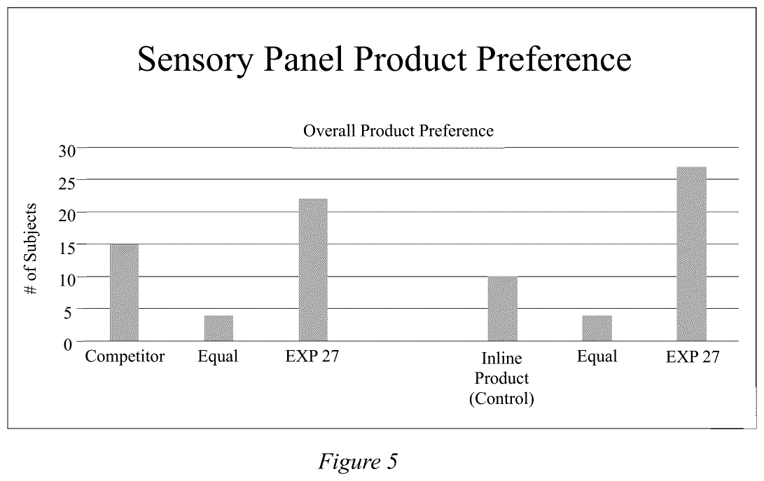

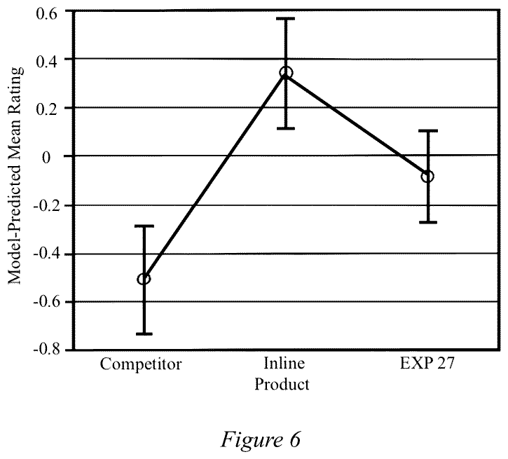

Users were asked to select which product they preferred based on a number of characteristics. Foam quantity, product feel during wash, rinse ability, ability to clean, skin feel after wash and overall likeability of each product were assessed. The users' responses from the questionnaires were tabulated and subjected to statistical analysis to determine the relative acceptability of the test and control products. The results are shown in Table 11 and FIGS. 5-6.

TABLE 11

| | Number of Preferred Responses | | | |
|---|---|---|---|---|
| Product | Competitor | Inline | Exp. 27 | Equal |
| Exp. 27 vs. Competitor | 20 | — | 37 | 26 |
| Exp. 27 vs. Inline Control | — | 18 | 41 | 23 |

FIG. 5 shows the overall product preferences of the panel and FIG. 6 illustrates the model-predicted differences between products. A Tukey-adjusted multiple comparison procedure showed highly significant differences between all three products since the Exp. 27 rating was closest to zero, it can be concluded that panelists liked the foam amount of Exp. 27 the best, averaged across lotioned and un-lotioned hand washes.

These data show that in handwashing experiments, most users prefer the compositions of the present disclosure, or at a minimum consider the user experience of the compositions of the disclosure to be comparable to existing products.

### Example 9

The following Packaging Engineering Lab Qualification study characterizes the capabilities of foaming pumps to consistently deliver a target volume of 0.6 ml dose per activation. The pump sample size was 11 pumps. The activation speed for use of the pumps was a 3-second cycle for evacuation (20 per minute) and a 20-second cycle for dosing (3 per minute). After dispensing, the volume of foam was measured for each dose. The target dose was 0.6 ml+/−10%. The product evaluated was Exp. 28 as described in Example 1. The results are shown in Table 12.

TABLE 12

| | |
|---|---|
| Initial Output Average | 0.657 ml |
| 60 Minute Output Average | 0.579 ml |
| Overall Average | 0.618 ml |

As shown in Table 12, the initial output data was higher on average. However, over a period of time (60 minutes) the dose normalizes. Thus, overall, on average, existing foaming pumps are able to consistently deliver the target dose of approximately 0.6 ml.

### Example 10

Test formulations were prepared as shown in Table 13 below and were given a user evaluation for their hand feel based on lather, slip, and residue/stickiness. The results are shown in Table 14. For the compositions described in Table 3, the representative, specific components evaluated were as follows: the phenolic preservative was phenoxyethanol, the betaine foam booster was cocamidopropyl betaine, the carboxylic acid salt preservative was sodium benzoate, the humectant skin health agent was glycerin, the APG secondary surfactant was a lauryl/myristyl glucoside such as Glucopon 625 UP, the anionic sulfate primary surfactant was SLES, the solvent was hexylene glycol, the skin condition skin health agent was aloe vera, the moisturizer skin health agent was panthenol, and the carboxylic acid pH adjusting agent was citric acid.

TABLE 3

| | Ex. 1 | Ex. 2 | Ex. 3 | Ex. 4 | Ex. 5 | Ex. 6 | Ex. 7 |
|---|---|---|---|---|---|---|---|
| Component | (wt. %) | (wt. %) | (wt. %) | (wt. %) | (wt. %) | (wt. %) | (wt. %) |
| Water | 80-85 | 80-85 | 85-90 | 85-90 | 85-90 | 85-90 | 85-90 |
| Phenolic | 0.5-1 | 0.5-1 | 0.5-1 | 0.5-1 | 0.5-1 | 0.5-1 | 0.5-1 |
| preservative | | | | | | | |
| Betaine foam | 2-4 | 2-4 | 2-4 | 2-4 | 2-4 | 2-4 | 2-4 |
| booster | | | | | | | |
| Carboxylic acid salt | 0.5-1 | 0.5-1 | 0.5-1 | 0.5-1 | 0.5-1 | 0.5-1 | 0.5-1 |
| preservative | | | | | | | |
| Humectant skin | 1-2 | 1-2 | 1-2 | 0.25-1 | 0.25-1 | 0.25-1 | 0 |
| health agent | | | | | | | |
| Alkylpolyglucoside | 1-2.5 | 1-2.5 | 1-2 | 1-2 | 1-2 | 1-2 | 1-2 |
| secondary surfactant | | | | | | | |
| Anionic sulfate | 8-9 | 9-10 | 6-7 | 6-7 | 6-7 | 6-7 | 6-7 |
| primary surfactant | | | | | | | |
| Solvent | 1-2 | 0 | 0.1-0.5 | 0.1-0.5 | 0.1-0.5 | 0.1-0.5 | 0.1-0.5 |
| Skin conditioner | 0.1-0.5 | 0.1-0.5 | 0.1-0.5 | 0.1-0.5 | 0.1-0.5 | 0.1-0.5 | 00.1-0.5 |
| skin health agent | | | | | | | |
| Moisturizer skin | 0 | 0 | 0.01-0.2 | 0.01-0.2 | 0.01-0.2 | 0.01-0.2 | 0.01-0.2 |
| health agent | | | | | | | |
| Carboxylic acid pH | 0.1-0.2 | 0.1-0.2 | 0.1-0.2 | 0.1-0.2 | 0.1-0.2 | 0.1-0.2 | 0.1-0.2 |
| adjusting agent | | | | | | | |

TABLE 4

| Evaluation | Ex. 1 | Ex. 2 | Ex. 3 | Ex. 4 | Ex. 5 | Ex. 6 | Ex. 7 |
|---|---|---|---|---|---|---|---|
| | Good | Good | Residue | Overall | Low | Low | Low |
| | lather, | lather, | present | Acceptable | lather, | lather, | lather, |
| | low | low | | | slip | slip | slip |
| | residue | residue | | | | | |

As shown in Table 4, Ex. 1, Ex. 2, and Ex. 4 performed well, providing good lather and low residue.

The embodiments being thus described, it will be obvious that the same may be varied in many ways. Such variations are not to be regarded as a departure from the spirit and scope of the disclosure and all such modifications are intended to be included within the scope of the following claims.

What is claimed is:

1. A foaming composition comprising:
a primary surfactant;
a secondary surfactant;
a foam booster; and
optionally a solvent;
wherein the composition is a ready-to-use (RTU) liquid having an air to composition ratio of between about 22-28 and about 1 when dispensed from a pump.

2. The composition of claim 1, wherein the primary surfactant is sodium laureth sulfate, sodium lauryl sulfate, sodium dodecyl benzene sulfonate, an alkyl sulfonate, an ether carboxylic acid, a sulfonated fatty acid, a cationic surfactant, a salt of C₁₂-C₁₆ saturated or unsaturated fatty acid, lauryl dimethyl amine oxide, myristyl dimethyl amine oxide, cetyl dimethyl amine oxide, or a combination thereof.

3. The composition of claim 1, wherein the secondary surfactant is a C₈-C₁₆ alkyl polyglucoside, C₁₂-C₁₆ alkyl polyglucoside, lauryl/myristyl glucoside, or a combination thereof.

4. The composition of claim 1, wherein the foam booster is a glyceryl caprylate/caprate sorbitan sesquicaprylate, phospholipid, polyethylene glycol, capric/caprylic monoglyceride, cocamidopropyl PG-dimonium chloride, cocamidopropyl betaine, or a combination thereof.

5. The composition of claim 1, wherein the solvent is an alcohol, alkanol amine, ether amine, glycol ether, hexylene glycol, or a combination thereof.

6. The composition of claim 1, wherein the composition comprises from about 1 wt. % to about 15 wt. % of the primary surfactant; from about 0.25 wt. % to about 5 wt. % of the secondary surfactant; from about 0.25 wt. % to about 5 wt. % of the foam booster; and up to about 5 wt. % of the solvent.

7. The composition of claim 1, wherein the composition further comprises an additional functional ingredient comprising water, a preservative, a pH modifier, a viscosity modifier, a skin health agent, an antimicrobial agent, a solubility modifier, a fragrance, a dye, a hydrotrope, buffer, additional surfactant, or a combination thereof.

8. The composition of claim 7, wherein the skin health agent comprises glycerin, aloe vera, polyethylene glycol, propylene glycol, Vitamin E, panthenol, urea, methyl gluceth-20, sorbitol, or a combination thereof, and wherein the skin health agent is present in an amount of between about 0.2 wt. % to about 2 wt. %.

9. The composition of claim 1, wherein the pH of the composition is between about 4 to about 9.5.

10. The composition of claim 1, wherein the composition is a foaming hand soap.

11. The composition of claim 10, wherein the hand soap does not cause irritancy to skin of a user and wherein the hand soap does not leave residue on the skin of the user.

12. The composition of claim 1, wherein the composition has a viscosity of less than 50 Cp·s.

13. The composition of claim 1, wherein the composition has a density of between about 18 ml/g to about 27 ml/g.

14. A method of removing soil from a tissue or surface comprising:
applying a foaming composition to a tissue or surface; and
removing the soil from the tissue or surface;
wherein the foaming composition comprises a primary surfactant, a secondary surfactant, a foam booster, and optionally a solvent, wherein the composition is a ready-to-use (RTU) liquid having an air to composition ratio of between about 22-28 and about 1 when dispensed from a pump.

15. The method of claim 14, further comprising a step of dispensing the composition using a foaming pump.

16. The method of claim 14, wherein the composition has a composition to air ratio of between about 22-28 and about 1.

17. The method of claim 14, wherein the composition is dispensed from the foaming pump in a dose having between about 0.3 ml to about 0.8 ml of the composition.

18. The method of claim 14, wherein the tissue is skin; wherein the surface is a hard surface comprising a table, countertop, tile, floor, wall, panel, window, food processing surface, or a combination thereof; and/or wherein the surface is a soft surface comprising paper, or a textile.

19. The method of claim 14, wherein the method does not require a step of priming the pump.

20. The method of claim 14, wherein the method does not require a step priming the pump more than once.
